(19) United States
(12) Patent Application Publication
(10) Pub. No.: US 2019/0279256 A1
(43) Pub. Date: Sep. 12, 2019

(54) SYSTEM AND METHOD FOR MAKING REAL-TIME DECISIONS FOR ROUTING COMMUNICATIONS AND INFORMATION IN A CONTACT CENTER

(71) Applicant: Avaya Inc., Santa Clara, CA (US)

(72) Inventors: Michael Sisselman, New York, NY (US); Oliver Huber, Mainz (DE); Wen-Hua Ju, Monmouth Junction, NJ (US); Rafael Luis Piva, Dois Córregos (BR); Andre Aragao, Highlands Ranch, CO (US)

(21) Appl. No.: 16/257,655

(22) Filed: Jan. 25, 2019

Related U.S. Application Data
(60) Provisional application No. 62/640,661, filed on Mar. 9, 2018.

(51) Int. Cl. G06Q 30/02; H04M 3/51; H04M 3/523; G06F 16/25

(52) U.S. Cl. CPC G06Q 30/0271; G06Q 30/0281; G06F 16/258; H04M 3/5238; H04M 3/5191

(57) ABSTRACT

A real-time or non-real-time communication from a customer communication endpoint is received. A work item is generated that represents the real-time or non-real-time communication. For example, a real-time voice communication is received and tracked in a contact center as a work item. First data from an external data service provider (DSP) is consumed. For example, the first data is received from an Experian® data service. The first data is natively provided by the external DSP in a first format. For example, the first format may be in Extended Markup Language (XML). The first data is converted into second data in a second format for use in a contact center. The second data in the second format is used to: 1) select a first offer from multiple offers; and 2) route the work item and the first selected offer to a communication element (e.g., an agent communication endpoint).

### CROSS REFERENCE TO RELATED APPLICATION

The present application claims the benefits of U.S. Provisional Application Ser. No. 62/640,661, filed Mar. 9, 2018, entitled “Real-Time Decisioning Using Consumer Information to Affect Offers for Prospects”, which is incorporated herein by this reference in its entirety.

### FIELD

The disclosure relates generally to contact centers and particularly to routing communication sessions and information in a contact center.

### BACKGROUND

Contact Centers routinely attempt to ascertain the identity of a caller, leverage whatever information is known about the caller, and then make a decision on how to best provide a differentiated customer-experience. This model works moderately well for existing customers for whom historical information is stored in a Customer Relationship Management (CRM) system or some other transactional application, which can be accessed at the time of the call. However, there may be times when there is little or no information about the caller in these enterprise applications, as is the case when the caller is responding for the first time to an advertisement. Lack of the necessary information about the caller causes the Contact Center to provide generic treatment for the caller. This is typically inefficient and leads to sub-optimal business results.

### SUMMARY

These and other needs are addressed by the various embodiments and configurations of the present disclosure. A real-time or non-real-time communication from a customer communication endpoint is received. A work item is generated that represents the real-time or non-real-time communication. For example, a real-time voice communication is received and tracked in a contact center as a work item. First data from an external data service provider (DSP) is consumed. For example, the first data is received from an Experian® data service. The first data is natively provided by the external DSP in a first format. For example, the first format may be in Extended Markup Language (XML). The first data is converted into second data in a second format for use in a contact center. The second data in the second format is used to: 1) select a first offer from multiple offers; and 2) route the work item and the first selected offer to a communication element (e.g., an agent communication endpoint).

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “Session Initiation Protocol” (SIP) as used herein refers to an IETF-defined signaling protocol, widely used for controlling multimedia communication sessions such as voice and video calls over Internet Protocol (IP). The protocol can be used for creating, modifying and terminating two-party (unicast) or multiparty (multicast) sessions consisting of one or several media streams. The modification can involve changing addresses or ports, inviting more participants, and adding or deleting media streams. Other feasible application examples include video conferencing, streaming multimedia distribution, instant messaging, presence information, file transfer and online games. SIP is as described in RFC 3261, available from the Internet Engineering Task Force (IETF) Network Working Group, November 2000; this document and all other SIP RFCs describing SIP are hereby incorporated by reference in their entirety for all that they teach.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “communication element” as described herein an in the claims can be or may include an agent communication endpoint, an Interactive Voice Response (IVR) system, a voicemail system, a contact center queue, a contact center pool, a chat bot, a text messaging bot, an email bot, a web site, an IVR menu, and/or the like.

The term “customer” as described herein and in the claims can be or may include any person who interacts with a contact center. For example, a “customer” may be a current customer of the contact center, a prospective customer of the contact center, a user, a caller, an individual, a group of individuals, and/or the like. A customer may interact with the contact center in various ways, such as, via a voice/video call, via an Instant Messaging (IM)/chat session, via a social media site, via a web server, via a virtual reality interface (e.g., using avatars to represent individuals in a communication session), via email, via text messaging, and/or the like

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for making real-time decisions for routing communications and information in a contact center.

FIG. 2 is a flow diagram of a process for making real-time decisions for routing communications and information in a contact center.

FIG. 3 is a flow diagram of a process for identifying customer attributes in a contact center.

FIG. 4 is a flow diagram of a process for using machine learning to adjust selection criteria for selecting offers in a contact center.

FIG. 5 is a flow diagram of a process for identifying a device type of the customer communication endpoint for formatting an offer.

FIG. 6 is a flow diagram of a process for identifying a device type of the customer communication endpoint for making offer/routing decisions.

### DETAILED DESCRIPTION

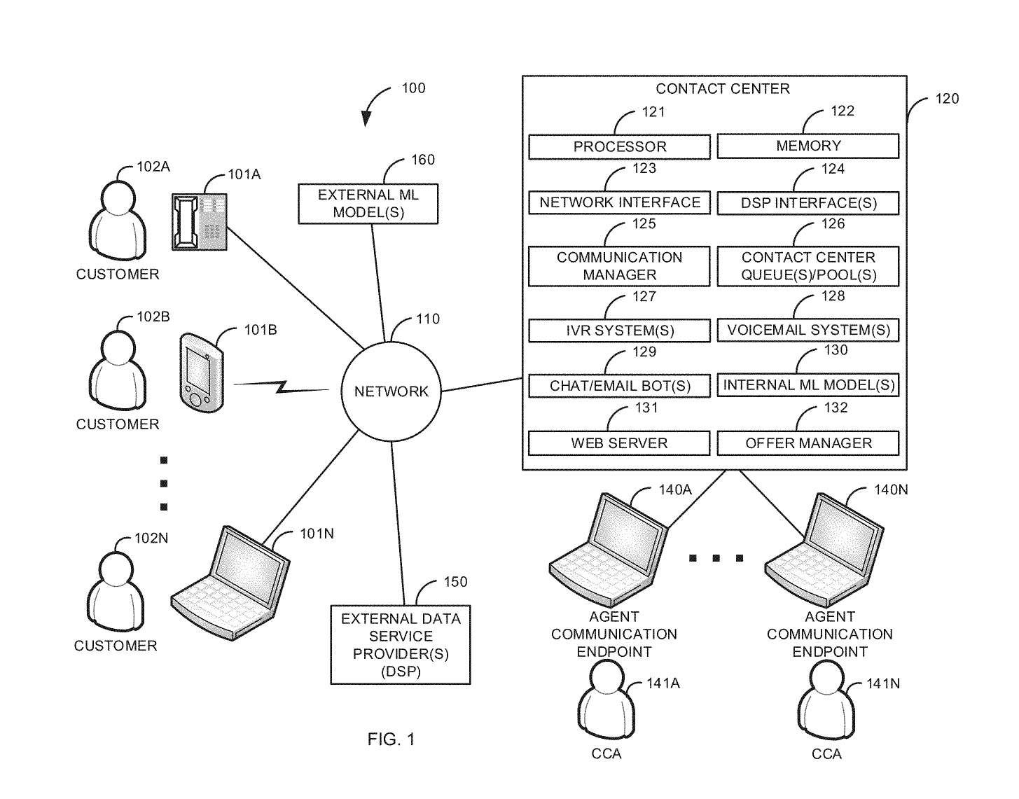

FIG. 1 is a block diagram of a first illustrative system 100 for making real-time decisions for routing communications and information in a contact center 120. The first illustrative system 100 comprises customer communication endpoints 101A-101N, a network 110, a contact center 120, agent communication endpoints 140A-140N, external Data Service Provider(s) (DSPs) 150, and external Machine Learning (ML) model(s) 160. FIG. 1 also shows corresponding customers 102A-102N for each customer communication endpoint 101A-101N. Likewise, FIG. 1 shows corresponding contact center agents 141A-141N for each agent communication endpoint 140A-140N.

The customer communication endpoints 101A-101N can be or may include any user device that can communicate on the network 110, such as a Personal Computer (PC), a telephone, a video system, a cellular telephone, a Personal Digital Assistant (PDA), a tablet device, a notebook device, a smartphone, a conferencing system, and/or the like. As shown in FIG. 1, any number of customer communication endpoints 101A-101N may be connected to the network 110. The communication endpoint 101A-101N are devices where a real-time/non-real-time communication ends.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), video protocols, Instant Messaging (IM) protocols, text messaging protocols, email protocols, and/or the like. Thus, the network 110 is an electronic communication network configured to carry messages via packets and/or circuit switched communications.

The contact center 120 can be or may include any contact center 120 that can provide services to the customers 102A-102N of the customer communication devices 101A-101N. The services may comprise various types of services, such as, technical support, sales, emergency services, and/or the like. A user may initiate (or receive) a real-time or non-real-time communication with the contact center 120 in various mediums, such as, a voice communication session, a video communication session, a multimedia communication session, a virtual reality communication session, an Instant Messaging (IM) communication session, an email communication session, a text messaging communication session, and/or the like.

The contact center 120 further comprises a processor 121, a memory 122, a network interface 123, a data service provider (DSP) interface(s) 124, a communication manager 125, contact center queue(s)/pool(s) 126, Interactive Voice Response (IVR) system(s) 127, voicemail system(s) 128, a chat/email bot(s) 129, internal Machine Learning (ML) model(s) 130, a web server 131, and an offer manager 132.

The processor 121 can be or may include any hardware processor, such as, a microprocessor, a multi-core processor, an application specific processor, a microcontroller, a digital signaling processor, and/or the like.

The memory 122 can be or may include any hardware memory 122, such as, a read-only memory, a Random Access Memory, a hard disk, a RAM disk, a flash memory, and/or the like.

The network interface 123 can be or may include any hardware network interface 123, such as, an Ethernet interface, a WiFi interface, a cellular interface, a fiber optic interface, a wired interface, an interface to the PSTN, and/or the like.

The DSP interface(s) 124 can be or may include any interface that allows the contact center 120 to communicate with the external data service provider(s) 150. For example, the DSP interface(s) 124 may be comprise separate Application Programming Interfaces (API) for each of the external data service provider(s) 150.

The communication manager 125 can be or may include any hardware coupled with firmware/software that can manage and route real-time/non-real-time communications and information in the contact center 120, such as, a Private Branch Exchange (PBX), an Automatic Call Distribution (ACD) system, a router, a network switch, an IM server, an email server, and/or the like. The communication manager 125 can manage and route various types of communications, such as, voice, video, multimedia, virtual reality, IM, email, text messaging, and/or the like.

The contact center queue(s)/pools 126 can be or may include any computer construct that can be used to hold one or more communications. The contact center queue(s) 126 can be used for holding a communication until it is routed to an agent communication endpoint 140. A contact center pool 126 can be used to hold a communication until selected by a contact center agent 141. For example, the contact center queue(s)/pool(s) 126 can be used to hold a voice communication that is eventually routed to the agent communication endpoint 140/contact center agent 141. The contact center queue(s)/pools 126 can hold any type of communication.

The IVR system(s) 127 can be or may include any system that can interact with a user via voice. The IVR system(s) 127 may include a video IVR system. The IVR system(s) 127 may be used to gather information from users to make routing decisions/offer decisions in the contact center 120. For example, the IVR system(s) 127 may be used to route an incoming video communication to a contact center queue/pool 126 based on different IVR menus that are selected by a customer 102.

The voicemail system 128 can be or may include any hardware coupled with software that allows a user to leave a voicemail. The voicemail system 128 may also include a video mail system.

The chat/email bot(s) 129 can be or may include any hardware coupled with software that can interact with a user via text, such as, a chat bot (e.g., an Instant Messaging bot), a text messaging bot, a web server bot, an email bot, and/or the like.

The internal Machine Learning (ML) model(s) 130 can be or may include any software that can that automatically be used to identify customer attributes/information, select offers, and/or route a communication(s). The internal ML model(s) 130 can be or may include any learning algorithm(s), such as, a linear regression algorithm, a logistic regression algorithm, a decision tree algorithm, a Naïve Bayes algorithm, a K-means algorithm, a Random Forrest algorithm, a gradient boosting algorithm and/or the like.

The web server 131 can be or may include any known web server 131, such as Apache™, IIS™, Nginx™, and/or the like. The web server 131 may provide an application to the customer communication endpoints 101A-101N via a browser in the customer communication endpoints 101A-101N.

The offer manager 132 can be or may include any firmware/software that can manage selection of offers/customer attributes. An offer can be or may include any type of offer that is being provided by the contact center 120. For example, an offer may be for a cruise package, a ski package at a five star hotel, a television, a stereo system, an incentive for a car purchase, a financing offer, an offer for a service, and/or the like.

The agent communication endpoints 140A-140N can be or may include any user communication device, such as the customer communication endpoint 101. In one embodiment, an agent communication device (e.g., 140A) may comprise multiple agent communication devices 140, such as a telephone and a personal computer.

The external Data Service Provider(s) (DSPs) 150, can be or may include any external system that can provide data to the contact center, such as, Experian®, the White Pages, the Yellow Pages, social media sites, weather services, consensus data, or any information source that can provide a context, and/or the like.

The external Machine Learning (ML) model(s) 160 can be or may include any machine learning models, such as, the internal ML model(s) 130. The external ML model(s) 160 may work in a similar manner as the internal ML model(s) 130. For example, an API may be provided in the contact center 120 to communicate with the external ML model(s) 160 in the same manner as the internal ML model(s) 130 are used.

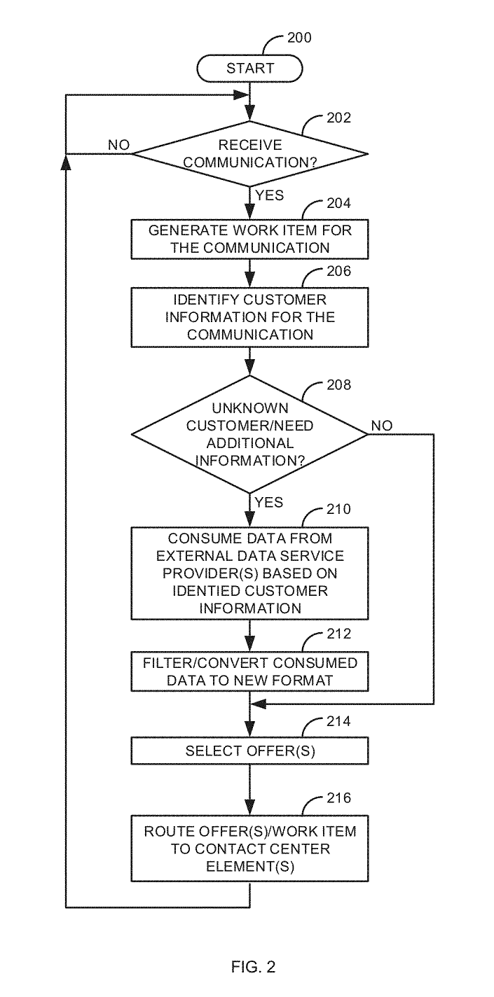

FIG. 2 is a flow diagram of a process for making real-time decisions for routing communications and information in a contact center 120. Illustratively, the customer communication endpoints 101A-101N, the network interface 123, the DSP interface(s) 124, the communication manager 125, the contact center queue(s)/pool(s) 126, the IVR system(s) 127, the voicemail system(s) 128, the chat/email bot(s) 129, the internal ML model(s) 130, the web server 131, the offer manager 132, the agent communication endpoints 140A-140N, the external DSP(s) 150, and the external ML model(s) 160 are stored-program-controlled entities, such as a computer or microprocessor, which performs the method of FIGS. 2-6 and the processes described herein by executing program instructions stored in a computer readable storage medium, such as a memory (i.e., a computer memory 122, a hard disk, and/or the like). Although the methods described in FIGS. 2-6 are shown in a specific order, one of skill in the art would recognize that the steps in FIGS. 2-6 may be implemented in different orders and/or be implemented in a multi-threaded environment. Moreover, various steps may be omitted or added based on implementation.

The process of FIG. 2 starts in step 200. The communication manager 125 determines, in step 202, if a communication has been received. A communication may be a voice communication, a video communication, a virtual reality communication (where a customer 102 interacts with a contact center agent 141 via virtual reality, such as avatars), an Instant Messaging (IM) communication, an email, a text message, a social media interaction (e.g., on Facebook®) and/or the like. If a communication has not been received in step 202, the process of step 202 repeats.

Otherwise, if a communication has been received in step 202, the communication manager 125 generates a work item for the communication in step 204. A work item is task that is handled by the contact center 120. A work item may be a voice call, a video call, an IM session, an email, a text message, a post on a social media site, a trouble ticket, a session with the web server 131, a virtual reality session, and/or the like. The work item may be routed to various communication elements, such as, the contact center queue(s)/pool(s) 126, the IVR system(s) 127, the voicemail system(s) 128, the chat/email bots 129, the web server 131, the agent communication endpoints 140A-140N, and/or the like.

The offer manager 132 identifies customer information for the communication in step 206. For example, a telephone number, an email address, a social media network handle, a network address, a Uniform Resource Identifier (URI), and/or the like may be identified in step 206 from the communication received in step 202. If the customer 102 has previously called the contact 120, there may be additional information associated with the customer 102 that can be identified in step 206, such as, a customer name, a customer telephone number, a customer address, a record of previous purchases/interactions, customer preferences, and/or the like (e.g., stored in a contact center customer database). In some cases, the customer 102 may not be known to the contact center 120. For example, if the customer 102 has never before interacted with the contact center 120, the offer manager 132 may not be able to precisely determine the identity of the individual(s) who are interacting with the contact center 120. In other words, the offer manager 132 may not have enough information to fully identify the individual/household. The offer manager 132 may only be able to identify a likelihood of the identity of the individual(s) who are interacting with the contact center 120. For example, the offer manager 132 may only have a postal code or location associated with a voice call, which results in a low likelihood that the caller is a specific individual.

The offer manager 132 determines, in step 208, if the customer 102 is unknown and/or if additional information is needed. For example, the customer 102 may be known to the contact center 120 (e.g., the customer 102 called several years ago), but the offer manager 132 may need to get more recent demographics/preferences (e.g., the customer's current annual income, the customer's latest address, the customer's likes/dislikes, the customer's associations, and/or the like) about the customer 102. The determination of whether additional information is needed may be based on various factors, such as, rules, thresholds, and/or the like. For example, the offer manager 132 may have a new rule to get the additional information based on not having key information associated with a new offer being provided by the contact center 120.

If additional information about the customer 102 is not needed in step 208, the process goes to step 214. Otherwise, if additional information is needed (i.e., the caller is unknown) in step 208, the offer manager 132 consumes, in step 210, data from the external DSP(s) 150 based the on identified information associated with the communication (or that which is obtained from the contact center database). For example, the only information the offer manager 132 may have is the caller's telephone number or email address. Based on the caller's telephone number or email address, the offer manager 132 makes a request(s), via the DSP interface 124(s) to get additional information that is associated with the telephone number/email address (e.g., the users name, address, income, etc.). The request via the DSP interface 124 consumes the information from the external DSP(s) 150 (e.g., Experian®, White Pages, and/or the like).

The data from the external DSP(s) 150 may be consumed, in step 210 in, various ways. For example, the data may be consumed by a single request to a single external DSP 150. The data of step 210 may be consumed by a series of requests to a single external DSP 150. For example, the first request may get general information about the customer 102. Based on the first request/rules, an additional request may be made to get more detailed information about the customer 102 from the same external DSP 150.

The data may be consumed by a series of requests to multiple external DSPs 150. For example, the first request may be made to a first external DSP 150 because the first external DSP 150 has more accurate customer information (but is less detailed and costs more). Based on the first request, a second request may be made to get additional information about the customer 102 from a second external DSP 150 (that is more detailed and less costly). The second request may be made because the first request does not provide the needed information or does not provide any information. This may because one external DSP 150 may contain information on a customer 102 that the other external DSP 150 does not. The additional request(s) may be made based on specific information and/or lack of specific information in the first request. The request(s) may be based on various factors, such as, poor coverage (e.g., an external DSP 150) may cover a small portion of customers 102), a limited accuracy (e.g., on external DSP 150 is more accurate than another), cost (e.g., a cost per request/type of data requested), geographic location (e.g., an external DSP 150 may only cover a specific country or state), and/or the like.

In one embodiment, the work item is placed in a contact center queue/pool 126 or on hold to allow time for the data to be consumed from the external DSP(s) 150.

One problem is that the data from different external DSPs 150 are typically in different data formats. The offer manager 132 filters/converts the consumed data to a new format in step 212 (e.g., into a format used by the offer manager 132). For example, the data from one external DSP 150 may be in Extended Markup Language (XML) and data from a second external DSP 150 may be in a different text format or in a binary format.

In addition, the data may be filtered. For example, based on different offers being offered by the contact center 120, certain information may be filtered because it is irrelevant. For instance, data related to whether the user likes to ski and do outdoor activities may be filtered out based on the current set of offers being related to the purchase of household appliances.

The offer manager 132 selects, in step 214, one or more offers (e.g., from a set of current offers) in step 214. For example, the contact center 120 may have the following offers: 1) a low end refrigerator without an ice maker, 2) a midrange refrigerator with an ice maker, 3) a high-end refrigerator with an ice maker, and 4) a high-end double size refrigerator with an ice maker. If the consumed data of step 210 indicated that the customer 102 has an annual income over $500,000 lives in a high-end community (housing prices over $1,000,000) in Florida (where it is typically hot) the offer for the high end-double size refrigerator with the ice maker may be selected in step 214 (and possibly the offer for the high-end refrigerator with the ice maker).

The communication manager 125 then routes the selected offer(s) and the work item to a contact center element in step 216. For example, the selected offer (for the high-end double size refrigerator) and the work item (e.g., a video call) are routed to one of the agent communication endpoints 140. The offer and the work item may be routed separately and/or at different times. For example, the work item may be routed to the contact center queue 126 and the offer(s) may be routed when the work item is sent to the agent communication endpoint 140 from the contact center queue 126. The process then goes back to step 202 to wait to receive a new communication.

Selecting/routing of the offer may include playing and/or displaying the offer to the customer 102, (e.g., playing in a message and/or the offer while the work item is on hold in the contact center queue 126), playing a video message and/or the offer while the work item is on hold in the contact center queue 126, sending a text message/offer while the work item is on hold in the contact center queue 126, and updating a web page with a message/offer while the work item is on hold in the contact center queue 126, and/or the like.

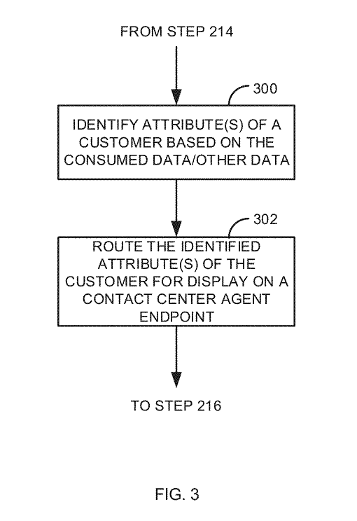

FIG. 3 is a flow diagram of a process for identifying customer attributes in a contact center 120. Customer characteristics can be or may include any type of information that is associated with the customer 102. For example, the customer attributes may be that the customer 102 is price sensitive (e.g., based on a low annual income), likes exclusive five star accommodations, likes a specific cruise line, and/or the like. The customer attributes allow a contact center agent 141 to better pitch the selected offer. For example, if the customer 102 is price sensitive, the contact center agent 141 can use this information when trying to sell the customer 102 to purchase a new television that is being discounted by 50%.

After the offer has been selected (could also be after steps 212 or 216) in step 214, the offer manager 132 identifies, in step 300, the customer attributes based on consumed data of step 210 and/or other data (e.g., previously stored contact center data). The communication manager 125 then routes, in step 302, the identified attributes of the customer 102 for display on an agent communication endpoint 140. The contact center agent 141 can then use this information when trying to pitch the offer(s) to the customer 102. The process then goes to step 216.

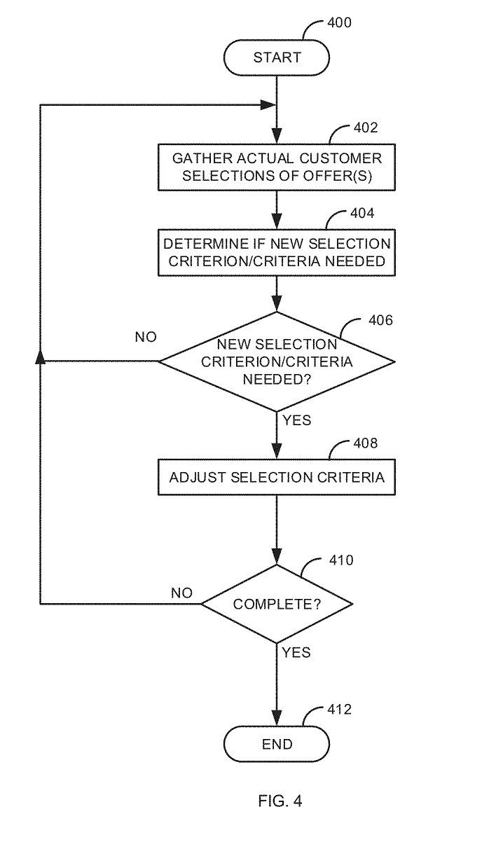

FIG. 4 is a flow diagram of a process for using machine learning to adjust selection criteria for selecting offers in a contact center 120. The process starts in step 400. The offer manager 132 gathers, in step 402, the actual offers that were selected by the customer 102. The offer manager 132 determines, in step 404, if new selection criterion/criteria are needed for selecting the offer (i.e., to be used in step 214). The offer manager 132 may determine in step 402 which offers were eventually purchased by the customers 102. For instance, out of one hundred offers (a history) where a first cruise package was selected in step 214, only five customers 102 actually purchased the first cruise package. However, for those same 100 offers, forty other customers 102 actually purchased a second cruise package. The offer manager 132 may use the internal ML model(s) 130/external ML model(s) 160 to determine if the current selection criteria/criterion are accurately generating optimized results. A selection criteria can be or may include any information that may be used to select the offer, such as a threshold (e.g., a percentage of sales), customer attributes (e.g., a demographic), a time of day, an association (e.g., works for a specific company), and/or the like. In this example, the offer manager 132 (using the internal ML model(s) 130 and/or external ML model(s) 160) may determine a different threshold (e.g. must have a 15% sale rate) and/or a new attribute(s) (e.g., the forty customers 102 all have a different common attribute, (e.g., all are from a same location in the country)) that will likely result in better selection of an offer.

If a new selection criterion/criteria is not identified in step 406, the process goes back to step 402. Otherwise, if new selection criterion/criteria is identified in step 406, the selection criterion/criteria are adjusted in step 408. Adjusting the selection criterion/criteria may include adjusting/changing criterion/criteria for routing of the work item and/or routing of the selected offer. How the selection criterion/criteria are adjusted in step 408 may be based on changing a threshold, adding a new selection criterion/criteria, removing a selection criterion/criteria, removing an existing offer(s), adding a new offer offer(s), changing routing of the selected offer to a different network element, changing an interactive voice response system menu (e.g., changing the IVR system menu to play a new offer or different message/menu), changing a message displayed by a bot, changing a view of a web page, changing an on-hold message, and/or the like.

The offer manager 132 determines, in step 410, if the process is complete. If the process is not complete in step 410, the process goes back to step 402. Otherwise, if the process is complete in step 410, the process ends in step 412.

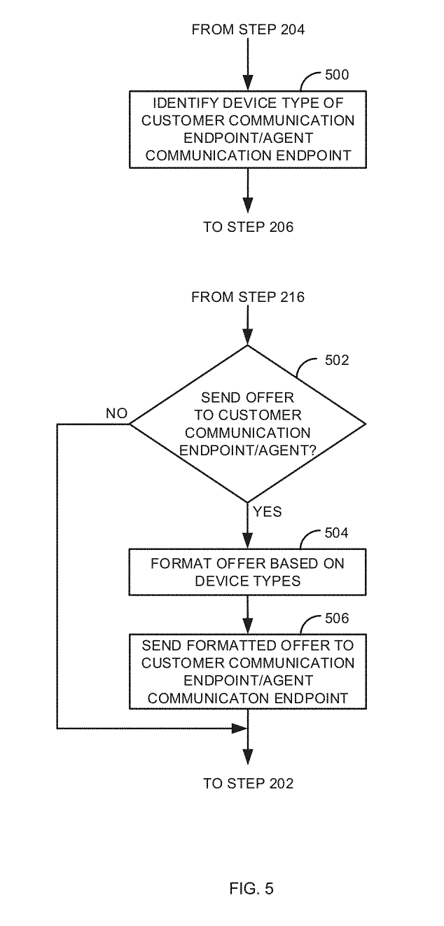

FIG. 5 is a flow diagram of a process for identifying a device type of the customer communication endpoint 101 for formatting an offer. The process of FIG. 5 is based on additional steps being added to FIG. 2. After generating the work item for the communication in step 204, the offer manager 132 identifies, in step 500, a device type for the customer communication endpoint 101/agent communication endpoint 140. For example, when the communication is received in step 202 (e.g., a SIP INVITE message), the message may include a device type for the customer communication endpoint 101. The device type may be in a specific header in the communication. The device type may be an administered device type for the customer communication endpoint 101/agent communication endpoint 140. The device type may indicate one or more attributes that distinguish the customer communication endpoint 101/agent communication endpoint 140 from other customer communication endpoints 101/agent communication endpoints 140. For example, the device type may indicate that the customer communication endpoint 101/agent communication endpoint 140 is a smart phone, a desktop PC, a tablet device, is a laptop device, a conferencing system, has a specific screen size, uses a mobile application, has a specific browser, does not have a screen (e.g., a telephone without a screen), and/or the like. The process then goes to step 206.

After step 216, the offer manager 132 determines, in step 502, if the offer needs to be sent to the customer communication endpoint 101/agent communication endpoint 140. The offer may be sent based on various reasons, such as, based on a screen size of the customer communication endpoint 101/agent communication endpoint 140, based on if the customer communication endpoint 101/agent communication endpoint 140 has a display, based on customer/administered preferences, and/or the like. In one embodiment, the offer may be sent verbally when there is no display.

If the offer is not to be sent to the customer communication endpoint 101/agent communication endpoint 140 in step 502, the process goes to step 202. Otherwise, if the offer is to be sent to the customer communication endpoint 101/agent communication endpoint 101 in step 502, the offer manager 132 formats the offer based on the device types in step 504. For example, if the device type indicates that one or both of the customer communication endpoint 101/agent communication endpoint 140 has a small screen, the offer may only include key points of the offer. The formatted offer is then sent to the customer communication endpoint 101 in step 506. The process then goes to step 202.

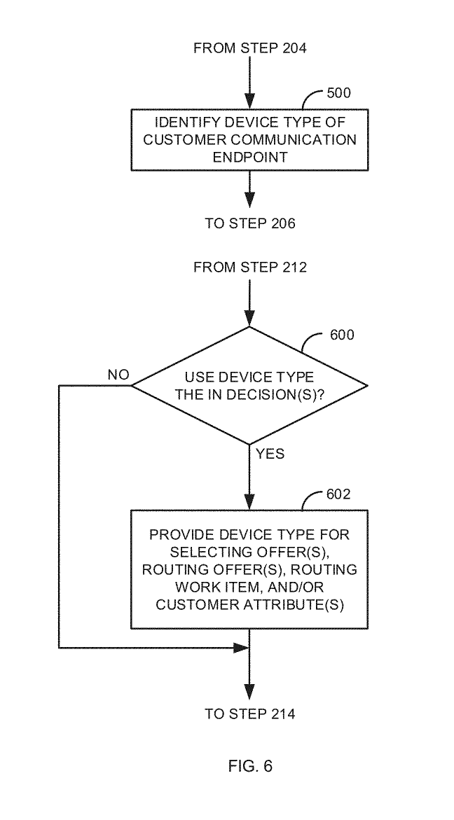

FIG. 6 is a flow diagram of a process for identifying a device type of the customer communication endpoint 101 for making offer/routing decisions. After generating the work item for the communication in step 204, the offer manager 132 identifies, in step 500 (as described in FIG. 5), a device type for the customer communication endpoint 101. The process then goes to step 206.

After the filtering/converting the consumed data in step 212, the offer manager 132 determines, in step 600, how the device type is to be used in the decision(s). For example, the offer manager 132 may determine that the device type is to be used in one or more of the decision(s) made in steps 216/302. For instance, if the device type of the customer communication endpoint 101 has a small screen size or no screen, the routing of the communication may go to the IVR system 127 instead being directed to the web server 131. Routing of the communication may go to a different contact center queue 126 based on a screen size of the customer communication endpoint 101. For example, one contact center queue 126 may be supported by contact center agents 141 that are better at explaining the offer verbally without any visual support. The device type may be used to help determine the offer. For example, based on a screen size, a different offer may be selected (e.g., one with less text).

If the device type is not to be used in the decisions in step 600, the process goes to step 214. Otherwise, if the device type is to be used in the decision(s) in step 600, the offer manager 132 provides the device type for selecting the offer(s), routing of the offer(s), routing the work item, and/or customer attributes (steps 216/302). The process then goes to step 214 where the device type is used to route offers/work items based on the provided information.

The processes described in FIGS. 1-6 are described using a contact center 120. However, in one embodiment, the processes described in FIGS. 1-6 can work outside of a contact center 120.

Examples of the processors 121 as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJS™ processors, other industry-equivalent processors, and may perform computational functions using any known or future-developed standard, instruction set, libraries, and/or architecture.

Any of the steps, functions, and operations discussed herein can be performed continuously and automatically. For example, the above steps can be implemented using various Artificial Intelligence algorithms.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors 121 (e.g., a single or multiple microprocessors), memory 122, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory 122, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
a server having a microprocessor, a computer memory, and a network interface, wherein the network interface receives a first real-time or non-real-time communication from a customer communication endpoint via a communication network and wherein the computer memory comprises instructions that, when executed by the microprocessor, cause the server to generate a work item representing the first real-time or non-real-time communication received from the customer communication endpoint; and
an additional interface that enables the server to consume first data from a first external Data Service Provider (DSP) that is natively provided by the first external DSP in a first format, wherein the instructions further enable the server to convert the first data consumed from the first external DSP from the first format into second data in a different second format, wherein the second data in the second format is used to: select, from a plurality of offers, a first selected offer, and route the work item and the first selected offer to a communication element.

2. The system of claim 1, wherein the system is a contact center and wherein the instructions further cause the server to:
identify third data in the received first real-time or non-real-time communication; and
determine, based on the third data, that a customer of the customer communication endpoint is unknown to the contact center, wherein the first data is consumed in response to determining that the customer of the customer communication endpoint is unknown to the contact center.

3. The system of claim 1, wherein the communication element is an agent communication endpoint and wherein selecting the first selected offer causes the server to:
identify, based on the second data, attributes of a customer of the customer communication endpoint; and
route the attributes of the customer of the customer communication endpoint to the agent communication endpoint for display on the agent communication endpoint.

4. The system of claim 1, wherein the instructions further cause the server to:
automatically adjust, based on a history of customer selected offers, one or more selection criteria, wherein the automatically adjusted one or more selection criteria are used to at least one of: change how a second offer is selected for a second real-time or non-real-time communication, remove a third offer from the plurality of offers, add a new offer to the plurality of offers, change routing of the second selected offer to a different network element, change an interactive voice response system menu, change a message displayed by a bot, and change a view of a web page.

5. The system of claim 1, wherein the first selected offer is selected based on calling a machine learning model.

6. The system of claim 1, wherein the communication element is at least one of: an agent communication endpoint, an interactive voice response system, a contact center queue, a contact center pool, a voicemail system, a chat bot, an email bot, a text messaging bot, a software application, and a web page.

7. The system of claim 1, wherein at least one of: the additional interface consumes third data from a second external DSP and the additional interface consumes the third data from the first external DSP, and wherein the third data is consumed based on information and/or lack of information in the first data.

8. The system of claim 1, wherein the communication element is a contact center queue, wherein the instructions further cause the server to provide information related to the first selected offer, and wherein in the information is provided in the form of at least one of: playing in a message while the work item is on hold in the contact center queue, playing a video while a video work item is on hold in the contact center queue, sending a text message while the work item is on hold in the contact center queue, and updating a web page while the work item is on hold in the contact center queue.

9. The system of claim 1, wherein the work item is placed in a contact center queue or on hold to allow time for the first data to be consumed from the first external DSP.

10. The system of claim 1, wherein the instructions further cause the server to:
identify a device type of the customer communication endpoint;
format the first selected offer based on the device type of the customer communication endpoint; and
send the formatted first selected offer to the customer communication endpoint.

11. The system of claim 1, wherein the instructions further cause the server to:
identify a device type of the customer communication endpoint, wherein the identified device type is used to at least one of: selected the first offer, route the work item to the communication element, route attributes of a customer to the communication element, and route the selected first offer to the communication element.

12. A method, comprising:
receiving, by a microprocessor, a first real-time or non-real-time communication from a customer communication endpoint via a communication network;
generating, by the microprocessor, a work item representing the first real-time or non-real-time communication received from the customer communication endpoint;
consuming, by the microprocessor, first data from a first external Data Service Provider (DSP) that is natively provided by the first external DSP in a first format; and
converting, by the microprocessor, the first data consumed from the first external DSP from the first format into second data in a second format, wherein the first and second formats are different and the second data in the second format is used to:
select from a plurality of offers, a first selected offer; and
route the work item and the first selected offer to a communication element.

13. The method of claim 12, further comprising:
identifying third data in the received first real-time or non-real-time communication; and
determining, based on the third data, that a customer of the customer communication endpoint is unknown to a contact center, wherein the first data is consumed in response to determining that the customer of the customer communication endpoint is unknown to the contact center.

14. The method of claim 12, wherein the communication element is an agent communication endpoint and wherein selecting the first selected offer further comprises:
identifying, based on the second data, attributes of a customer of the customer communication endpoint; and
routing the attributes of the customer of the customer communication endpoint to the agent communication endpoint for display on the agent communication endpoint.

15. The method of claim 12, further comprising:
automatically adjusting, based on a history of customer selected offers, one or more selection criteria, wherein the automatically adjusted one or more selection criteria are used to at least one of: change how a second offer is selected for a second real-time or non-real-time communication, remove a third offer from the plurality of offers, add a new offer to the plurality of offers, change routing of the second selected offer to a different network element, change an interactive voice response system menu, change a message displayed by a bot, and change a view of a web page.

16. The method of claim 12, wherein the communication element is at least one of: an agent communication endpoint, an interactive voice response system, a contact center queue, a contact center pool, a voicemail system, a chat bot, an email bot, a text messaging bot, a software application, and a web page.

17. The method of claim 12, wherein the microprocessor at least one of: consumes third data from a second external DSP and consumes the third data from the first external DSP, and wherein the third data is consumed based on information and/or lack of information in the first data.

18. The method of claim 12, wherein the communication element is a contact center queue and further comprising:
providing information related to the first selected offer, and wherein in the information is provided in the form of at least one of: playing in a message while the work item is on hold in the contact center queue, playing a video while the work item is on hold in the contact center queue, sending a text message while the work item is on hold in the contact center queue, and updating a web page while the work item is on hold in the contact center queue.

19. The method of claim 12, wherein the work item is placed in a contact center queue or on hold to allow time for the first data to be consumed from the first external DSP.

20. The method of claim 1, further comprising:
identifying a device type of the customer communication endpoint, wherein the identified device type is used to at least one of: selected the first offer, route the work item to the communication element, route attributes of a customer to the communication element, and route the selected first offer to the communication element.
